(19) United States
(12) Patent Application Publication
(10) Pub. No.: US 2021/0349644 A1
(43) Pub. Date: Nov. 11, 2021

(54) DEVICE FOR MANAGING DISTRIBUTED STORAGE RESOURCES AND METHOD FOR MANAGING SUCH STORAGE RESOURCES

(71) Applicant: HONGFUJIN PRECISION ELECTRONICS(TIANJIN)CO.,LTD., Tianjin (CN)

(72) Inventor: CHENG-WEI LUO, New Taipei (TW)

(21) Appl. No.: 16/885,997

(22) Filed: May 28, 2020

(30) Foreign Application Priority Data
May 9, 2020 (CN) 202010389087.1

(51) Int. Cl. G06F 3/06

(52) U.S. Cl. CPC G06F 3/0631; G06F 3/067; G06F 3/0664; G06F 3/0604

(57) ABSTRACT

A device for managing storage resources includes a plurality of servers with storage devices, a setting module, a first establishing module, and a second establishing module. The setting module includes a plurality of first storage devices in each server to be a virtual hard disk. When any other storage device of a server is damaged, the storage managing device maps the virtual hard disk with a new storage device and establishes a logical storage device, to perform data access operations on the logical storage device. A related method and a related non-transitory storage medium are also provided.

### FIELD

The subject matter herein generally relates to data storage.

### BACKGROUND

Mass-storage servers have evolved from a single mass-storage server to a distributed system which is composed of numerous, discrete, storage servers networked together. In order to maintain the high availability of the data or to avoid data loss through hard disk damage, a copy of the data is copied and stored on the hard disks of different servers. When these hard disks or servers are damaged, the number of backup copies will be reduced. When the distributed data storage system detects this situation, it will trigger the data backfill action.

Therefore, improvement is desired.

### BRIEF DESCRIPTION OF THE DRAWINGS

Implementations of the present disclosure will now be described, by way of embodiments, with reference to the attached figures.

FIG. 1 is a block diagram of an embodiment of a device for managing storage resources of the present disclosure.

FIG. 2 is a block diagram of an embodiment of a processor of the device of FIG. 1.

FIG. 3 is a schematic diagram of an embodiment of the storage resource managing device of FIG. 1.

FIG. 4 is a schematic diagram of another embodiment of the storage resource managing device of FIG. 1.

FIG. 5 is a flowchart of an embodiment of a method for managing storage resources.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessary to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

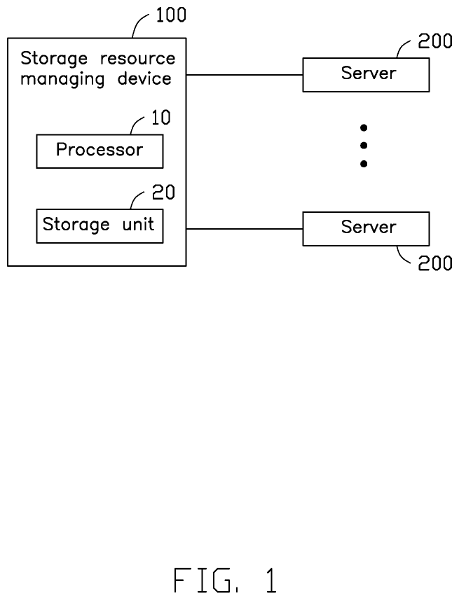

FIG. 1 illustrates a storage resource managing device 100 in accordance with an embodiment of the present disclosure. The storage resource managing device 100 is connected to a plurality of servers 200 via a communication network. The storage resource managing device 100 is configured to manage a plurality of storage devices of the servers 200. In the embodiment, the storage resource managing device 100 is a management server.

The storage resource managing device 100 can include, but is not limited to, a processor 10 and a storage unit 20. The storage resource managing device 100 can be connected to each server 200 via a plurality of wires or be connected to each server 200 via a wireless network, for example, a WI-FI, a wireless local area network, or the like.

In the embodiment, the storage unit 20 can be a read only memory (ROM) or a random access memory (RAM). The storage resource managing device 100 and the servers 200 can be arranged in an environment of a machine room.

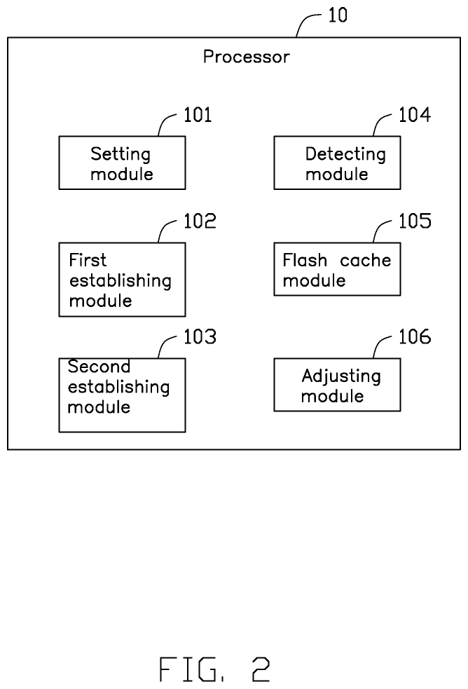

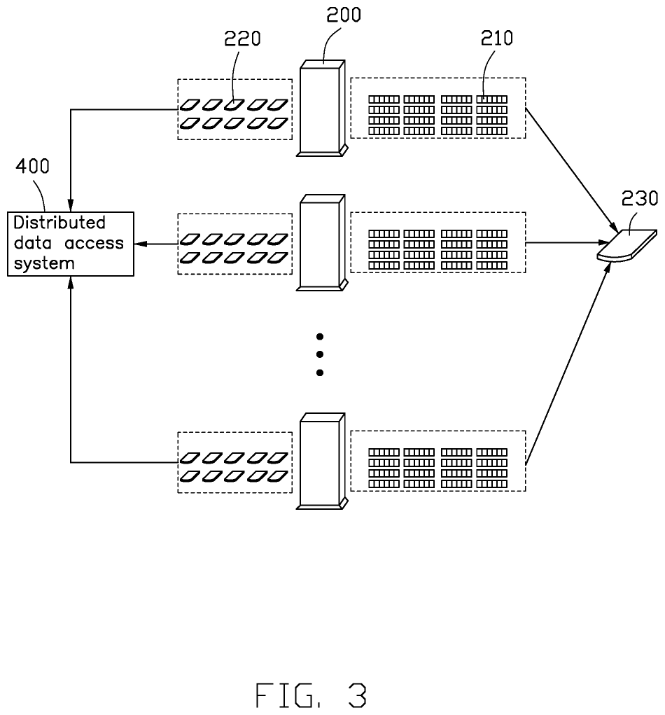

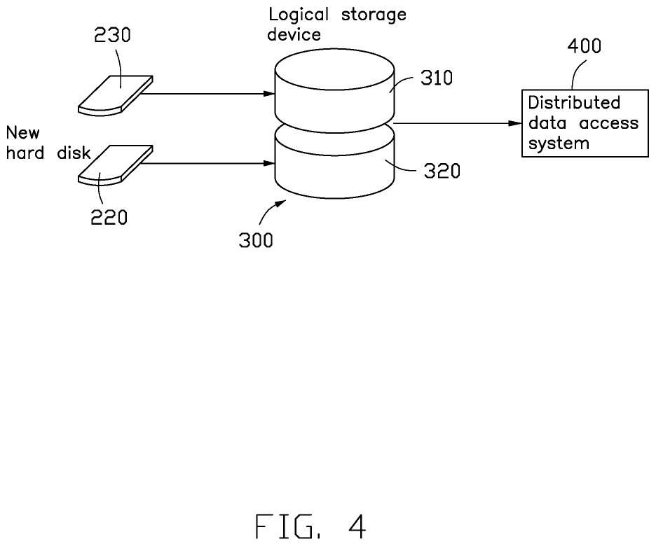

FIGS. 2-4 illustrate that the server 200 includes a plurality of first storage devices 210 and a plurality of second storage devices 220. The first storage devices 210 and the second storage devices 220 are used to store data. In the embodiment, the first storage device 210 is a memory, and the second storage device 220 is a hard disk drive (HDD). The stored data is program code and/or software data. Therefore, the storage resource managing device 100 can connect the HDDs on the server to each other through a network to form a large-scale storage system, that is, the HDDs on the server are connected to each other to form distributed data access system 400.

As shown in FIG. 2, the storage resource managing device 100 may include a setting module 101, a first establishing module 102, a second establishing module 103, a detecting module 104, a flash cache module 105, and an adjusting module 106. In the embodiment, the aforementioned modules can be a set of programmable software instructions stored in the storage unit 20 and executed by the processor 10 or a set of programmable software instructions or firmware in the processor 10.

The setting module 101 is used to form the first storage devices 210 in each server 200 into a hard disk (not shown in the figure) providing emulation.

In the embodiment, each server has 10 HDDs as an example. The number of servers and their included HDDs can be adjusted according to actual needs.

For example, a storage server usually does not need much memory space. There are a total of 16 memory slots on the server 200, and usually only four 32 GB memories (128 GB in total) are inserted to save hardware costs. The remaining 12 memory slots are also filled with 32 GB of memory (a total of 384 GB). The 384 GB of memory will be reserved for subsequent data backfill. Suppose there are 20 in number of a server 200, and each server 200 has ten 10 TB hard drives for the storage system. Since the memory of each server 200 is full, each server 200 has an additional 384 GB of memory space. Therefore, the setting module 101 can build these memory spaces into a memory emulation hard disk (RAM Disk) with a storage capacity of 384 GB. Thus, these 20 servers 200 have a total of 20 of 384 GB emulation hard disks.

In the embodiment, the first establishing module 102 is used to map each emulation hard disk to establish a virtual hard disk 230.

For example, the storage resource managing device 100 may use distributed storage tools to establish the 20 emulation hard disks into a distributed storage system. The first establishing module 102 further creates a virtual hard disk 230 with a storage capacity of 7680 GB from the system.

When any one of the second storage devices 220 of the server 200 is damaged, the second establishing module 103 is used to map the virtual hard disk 230 to a new second storage device 220 to establish a logical storage device 300, so as to perform data access operations on the newly created logical storage device 300. The newly created logical storage device 300 will use the virtual hard disk as a read-write cache space, and the newly created logical storage devices are used to replace HDD as the basic storage device of the distributed data access system, the logical storage device 300 can greatly improve the access speed.

In the embodiment, when the first storage devices 210 in each server are in an idle state, the first storage devices 210 in each server may be formed into an emulation hard disk or part of an emulation hard disk.

The emulation hard disk has a first storage capacity, the virtual hard disk has a second storage capacity, and the second storage capacity is greater than the first storage capacity.

In the embodiment, the second establishing module 103 preferably maps the virtual hard disk 230 with the new second storage device 220 through a flash cache module 105 to establish the logical storage device 300. The flash cache module 105 may include a BCACHE or FLASHCACHE software package.

If a hard disk is damaged and replaced with a new hard disk, the data backfill can be performed by the first establishing module 102 and the second establishing module 103.

The logical storage device 300 uses the virtual hard disk 230 as a cache device for the new hard disk, that is, the virtual hard disk 230 is a cache device 310 in the logical storage device 300, and the new hard disk is the backing device 320 in the logical storage device 300. When the logical storage device 300 is established, the adjusting module 106 adjusts the cache mode to the write back mode. When data is written to the logical storage device 300, as long as the data is written to the cache device 310, the write operation is completed.

The data backfilled by the remaining hard disks will start to be written to the cache device 310 of the logical storage device 300, and the virtual hard disk will be virtualized by the memory space reserved by all servers. When all the data that needs to be backfilled into the new hard disk is written to the cache device 310, the data backfill action will end.

After the backfill action ends, the adjusting module 106 converts the cache mode to a write around mode. New write requirements are directly written to the backing device 320, the storage function of the cache is released from the logical storage device 300, and only the original backing device is left to provide the storage service of the distributed data access system.

When the storage of the cache device 310 is released, the data stored in the cache device 310 will be flushed into the backing device 320, and the action will be executed in the operating system of the server. After flushing, the backing device 320 can operate independently in the distributed storage system.

In the embodiment, all the memory space reserved by the server 200 is used as the cache space of the new replacement hard disk, the cache mode is set to the write back mode, and the backfill data from other hard disks can be first stored in the cache space virtualized by the memory. Because the data transmission of the memory is through electronic signals, not the same as the hard disk, it is generally limited by the speed of the physical hard disk rotation. Therefore, the cache space virtualized by the memory is at least 100 times faster than the hard disk.

For example, if a user is only relying on the IO performance of the new hard disk, it takes approximately 167 hours to backfill all the data to the new hard disk, and the data backfilling operation of the distributed storage system is ended. If the storage resource management method is used, the data can be written to the cache space virtualized by the memory in about 1.67 hours. At this time, the data backfilling action of the distributed storage system is ended. The remaining part of the cache device 310 to write data back to the backing device 320 is executed by the operating system of the server to which the new hard disk belongs, and the write speed of the new hard disk can reach 100 MB/s or more.

During the backfilling data process of the comparative embodiment 1 and the embodiment 1, obtaining and recording parameters are shown in Table 1

TABLE 1
Test results of the embodiment 1 and comparative embodiment 1

| | | | | Time | |
|---|---|---|---|---|---|
| | | | Time | required | |
| | Backfill | Local | required to | from cache | Total |
| | data | backfill | backfill | device flush | data |
| | volume/ | speed/ | data to | to backing | backfill |
| | TB | MB/s | local/hour | device/hour | time/hour |
| Comparative | 6 | 10 | 167 | N/A | 167 |
| Embodiment 1 | | | | | |
| Embodiment 1 | 6 | 1000 | 1.67 | 16.7 | 18.37 |

Table 1 shows, the embodiment 1 can make the required data backfill time 9 times faster than the data backfill method in the comparative embodiment 1.

The memory space (7680 GB) reserved by the 20 servers is just large enough to completely store 6 TB of data written by the backfill of the other 199 hard disks.

When the distributed storage system cluster is large enough, the remaining empty memory slots are largely vacant (each server has 12 empty slots), if all the slots can be filled with memory and used as a cache for data backfill, it can make the utilization rate of the server higher and the use of the computer room more efficient.

In the embodiment, if the first storage device 210 of the server 200 is damaged, the storage resource managing device 100 can repair the server according to the following operations.

First, the detecting module 104 detects the damaged first storage device 210 and confirms its position on the server 200, and then replaces the damaged first storage device 210 with a new first storage device 210. The detecting module 104 may include a memory test software package.

Next, the setting module 101 will use the new first storage device 210 and the undamaged first storage device 210 to recreate an emulation hard disk.

Further, the first establishing module 102 recreates a virtual hard disk and adds it back to the distributed data access system. The second establishing module 103 will use tools (such as BCACHE or FLASHCACHE) to recreate the logical storage device with the new hard disk to be backfilled, and finally add it back to the original distributed data access system to execute the data backfill.

In the embodiment, if the new hard disk is damaged, the storage resource managing device 100 can repair the server according to the following operations.

First, users can replace the damaged hard disk with a new hard disk. The detecting module 104 performs a smart control check on the new hard disk, to confirm that the new hard disk is satisfactory.

Next, the second establishing module 103 will use tools (such as BCACHE or FLASHCACHE) to recreate the logical storage device with the virtual hard disk, and finally add the logical storage device back to the original distributed data access system to execute the data backfill.

In the embodiment, if the server where the new hard drive is located is damaged, the storage resource managing device 100 can repair the server according to the following operations.

After shutdown, the detecting module 104 detects damaged components of the server and replaces related components, and then activates them on to confirm that they are normal. The first establishing module 102 recreates a virtual hard disk from the reserved memory space of the server, and finally adds the virtual hard disk back to the original distributed data access system.

Next, the second establishing module 103 will use tools (such as BCACHE or FLASHCACHE) to recreate the logical storage device with the new hard disk to be backfilled, add it back to the original distributed data access system to execute the data backfill, and finally add the logical storage device back to the original distributed data access system to execute the data backfill.

The storage resource managing device 100 reduces the risk of data loss in the backfill process and improves the security of the data.

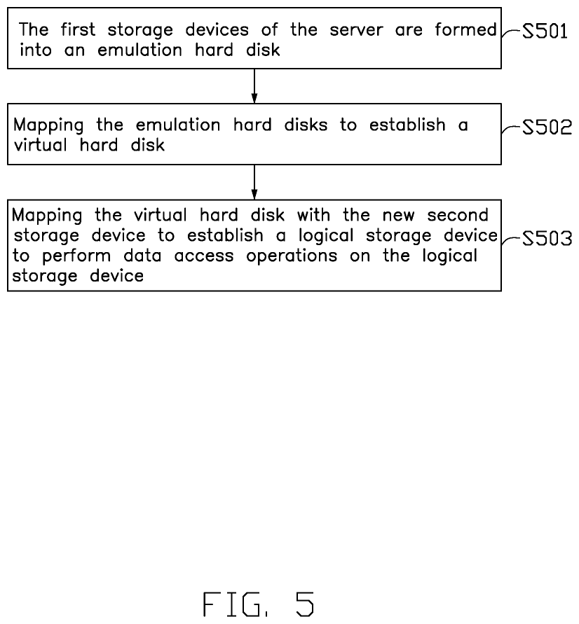

FIG. 5 illustrates a flowchart of a method for managing storage resources. The method for managing storage resources may include the following steps.

In block S501, the first storage devices of the server are formed into an emulation hard disk.

In block S502, mapping the emulation hard disks to establish a virtual hard disk.

In block S503, mapping the virtual hard disk with the new second storage device to establish a logical storage device, to perform data access operations on the logical storage device.

When any one of the plurality of second storage devices of the server 200 is damaged, the storage resource managing device 100 maps the virtual hard disk with the new second storage device and establishes a logical storage device, to perform data access operations on the logical storage device. Therefore, the storage resource managing device and method greatly reduce the risk of data in the backfill process and improve the security of the data.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

1. A storage resource managing device communicating with a plurality of servers and comprising:
a storage system; and
a processor;
wherein the storage system stores one or more programs, which when executed by the processor, cause the processor to:
form a plurality of storage devices of the server into an emulation hard disk;
map the emulation hard disks to establish a virtual hard disk;
map the virtual hard disk to new second storage device to establish a logical storage device to perform data access operations on the logical storage device when any one of the second storage devices of the server is damaged; and
form the first storage devices of the server into the emulation hard disk when the first storage devices of server are in an idle state.

2. (canceled)

3. The storage resource managing device according to claim 1, wherein the emulation hard disk has a first storage capacity, the virtual hard disk has a second storage capacity, and the second storage capacity is greater than the first storage capacity.

4. The storage resource managing device according to claim 3, further causing the at least one processor to:
detect a location of a damaged first storage device on the server, and map the new first storage device with the undamaged first storage device to establish an emulation hard disk when the first storage device of the server is damaged.

5. The storage resource managing device according to claim 4, further causing the at least one processor to:
detect damaged components of the server and reform the first storage devices in the server to the emulation hard disk, and map newly formed emulation hard disks in the server to establish the virtual hard disk.

6. A storage resource managing method for a storage resource managing device, applicable in a storage resource managing device configured to enable the storage resource managing device to communicate with a plurality of servers, a storage system, and a processor, comprising:
the processor forming a plurality of storage devices of the server into an emulation hard disk;
the processor mapping the emulation hard disks to establish a virtual hard disk;
the processor mapping the virtual hard disk to new second storage device to establish a logical storage device to perform data access operations on the logical storage device when any one of the second storage devices of the server is damaged; and
the processor forming the first storage devices of the server into the emulation hard disk when the first storage devices of server are in an idle state.

7. (canceled)

8. The storage resource managing method according to claim 6, wherein the emulation hard disk has a first storage capacity, the virtual hard disk has a second storage capacity, and the second storage capacity is greater than the first storage capacity.

9. The storage resource managing method according to claim 8, further comprising:
the processor detecting a location of a damaged first storage device on the server, and mapping the new first storage device with the undamaged first storage device to establish an emulation hard disk when the first storage device of the server is damaged.

10. The storage resource managing method according to claim 9, further comprising:
the processor detecting damaged components of the server and reforming the first storage devices in the server to the emulation hard disk, and mapping newly formed emulation hard disks in the server to establish the virtual hard disk.

11. A non-transitory storage medium storing a set of instructions, when the instructions being executed by a processor of a storage resource managing device, the processor being configured to perform a storage resource managing method, wherein the method comprises:
the processor forming a plurality of storage devices of the server into an emulation hard disk;
the processor mapping the emulation hard disks to establish a virtual hard disk;
the processor mapping the virtual hard disk to new second storage device to establish a logical storage device to perform data access operations on the logical storage device when any one of the second storage devices of the server is damaged; and
the processor forming the first storage devices of the server into the emulation hard disk when the first storage devices of server are in an idle state.

12. (canceled)

13. The non-transitory storage medium according to claim 11, wherein the emulation hard disk has a first storage capacity, the virtual hard disk has a second storage capacity, and the second storage capacity is greater than the first storage capacity.

14. The non-transitory storage medium according to claim 13, wherein the method further comprises:
the processor detecting a location of a damaged first storage device on the server, and mapping the new first storage device with the undamaged first storage device to establish an emulation hard disk when the first storage device of the server is damaged.

15. The non-transitory storage medium according to claim 14, wherein the method further comprises:
the processor detecting damaged components of the server and reforming the first storage devices in the server to the emulation hard disk, and mapping newly formed emulation hard disks in the server to establish the virtual hard disk.
